(19) United States
(12) Patent Application Publication
(10) Pub. No.: US 2018/0089717 A1
(43) Pub. Date: Mar. 29, 2018

(54) Digital Content Management and Delivery System for Digital Electronic Displays

(71) Applicants: Robert L. Morin, Glen Allen, VA (US); Michael W. Stephens, Glen Allen, VA (US)

(72) Inventors: Robert L. Morin, Glen Allen, VA (US); Michael W. Stephens, Glen Allen, VA (US)

(21) Appl. No.: 15/718,293

(22) Filed: Sep. 28, 2017

Related U.S. Application Data
(60) Provisional application No. 62/401,023, filed on Sep. 28, 2016.

(51) Int. Cl. G06Q 30/02; G06F 3/14; G09G 5/00

(52) U.S. Cl. CPC G06Q 30/0261; G06F 3/1454; G09G 5/003; G06Q 30/0269; G09G 2320/08; G06Q 30/0272; G09G 2380/06; G09G 2370/022; G09G 2354/00; G06Q 30/0273

(57) ABSTRACT

A method, system, device and computer program for creating, storing, collecting data, analytically processing, and delivering data displaying content via digital electronic signs, digital message boards and other designated display devices (collectively, Digital Electronic Displays or DED's) based upon predefined sets of display criteria. Such Display Criteria may include date, time, and other user-defined conditions. The System and method may integrate with third-party Systems to facilitate creation, modification, transfer, downloading and storage of digital images, graphics and files. Additionally, System and method may allow distribution of functional controls to one or more designated non-affiliated users (users not affiliated with DED owner). Embodiments may further include detailed reporting capabilities for management and monetization of displayed Content to include information such as: Content identifier; number of times or percentage of total time Content is displayed within a set period; number of “impressions” or views; User, Sub-User, Advertiser information; or other information related to marketing, commercial value or DED performance.

This application claims the benefit of U.S. Provisional Patent Application No. 62/401,023, filed Sep. 28, 2017, which is incorporated by reference herein in its entirety.

The field of the present invention is systems and methods for managing, scheduling and delivering text, images, videos, or graphics, collectively also referred to as content, for display on electronic signage systems including billboards, electronic message centers, electronic message boards, on premise digital signs and other electronic displays and monetizing that use, the system investment and cost of its operation.

### BACKGROUND AND CURRENT METHODS

The value and benefits of digital electronic signs, digital message boards and other designated display devices (collectively, Digital Electronic Displays or DED's) as “on-premise” signs (signs physically located on an establishment's property and viewable from roadways) are well-known by retailers, service providers and non-profit organizations and are deployed by a growing number of establishments located on or near a public thoroughfare. The primary function of such signs is advertising and promotion. DED's may also serve a secondary function of wayfinding (presenting the identity and location of an establishment) and public messaging.

A very important and valuable capability of DED's is changeability. This feature enables sign users to periodically vary the displayed information to communicate important messages and promote their business. Typically, these messages will include a general business description; product or service descriptions; promotional offers; community announcements, etc.

Changeability is of particular value in applications where multiple messages need to be displayed from a single sign or display. Examples include multi-brand retail establishments where single stores may promote many brands which they sell; and multi-tenant properties where more than one retailer or other establishment, advertiser or user is co-located within a single property or other geographic boundary (such as a strip mall, shopping center, shopping district, large business center, etc.). Unfortunately, static (non-changeable) on-premise signs or manually changeable signs (eg, reader boards) are physically or practically limited to how often advertisements or other message content can be displayed or changed.

Current DED Systems present numerous limitations that impede a sign owner, other DED users and advertisers from realizing the full value of the DED's marketing potential; and consequently limit the effectiveness of DED use and deter wider adoption, particularly by multi-brand advertisers and multi-tenant property owners. Such limitations include non-integrated systems; centralized control; minimal functional, reporting and scheduling capabilities; and ineffective means to monetize the advertising value of the DED's.
Non-integrated Systems—DED's often require products, systems or services from multiple sources just to perform the essential functions of creating and displaying content: one source produces graphics for display; another source stores the graphics; another source schedules when they should be shown; and another source may “play” (or display) the graphics on the DED. This composite solution adds to the complexity of DED operation, creates inefficiencies and delays within the process, and discourages greater utilization of sign features and capabilities.
Centralized control—Current DED systems are mostly designed for use by those affiliated with the DED owner with centralized control and functionality. Such designs typically burden a single individual with performing or managing all or most of the steps necessary for content to appear on the DED. These individuals, usually the sign owner or a property manager, have little or no training in graphics, advertising or technology as it is not a core function of their regular duties. Additionally, they have little time to devote to any single aspect of DED operation much less the overall hands-on operation and control. Furthermore, such individuals do not directly benefit from the content displayed on the DED (as the content relates to their tenants, etc.). Therefore, they have little motivation or interest in the effective utilization of the DED and are satisfied with getting a minimal set of content up and running on the display and minimizing any changes. These system designs create significant inefficiencies in the display process and minimize messaging effectiveness particularly for non-affiliated users and at multi-tenant properties
Limited functions, reporting and scheduling—Current DED systems typically lack many or most of the basic capabilities commonly employed by other forms of digital advertising: playlist generation (grouping sets of presentations); Dayparting (scheduling presentations according to time of day, day of week); calendar scheduling or scheduling based on other conditions (Display Criteria) and Proof of Play (PoP) reporting. The lack of such features result in additional inefficiencies and inability to easily monetize the investment.
Lack of value generation—The designs of current DED systems have given little consideration to measuring critical elements relating to advertising value including the frequency or display time of individual content files or groups of content files, quantity of viewers (“Impressions”), capturing and storing the associated data, processing the data, and reporting the information in a form meaningful to advertisers and their vendors.

The value of targeted marketing is well-known within the advertising industry. The ability to vary message content and timing based upon demographic profile of consumers and other factors have proven to be far more effective for advertising than general, broad-based messaging. The value of such targeting to marketers is reflected in advertising pricing across all media, which increase in correlation with the degree and accuracy of targeting.

The degree of targeting is primarily limited by the media form of the advertising. For instance, an ad in a newspaper or magazine can be aimed at the average demographic of the readership; however some targeting refinement can be achieved by placing ads in select content sections (i.e., Sports section). Television or radio may offer slightly improved targeted advertising during select programs or times of day which attract a narrower and more refined demographic profile than the average viewing population. In these traditional media scenarios, marketers choose which ads to display based upon the demographic profile of the average viewer.

Meanwhile, Internet or mobile media allow highly targeted advertising with the ability to identify individual profiles. Differing from traditional media, marketers do not choose which program or web site to display their ad. Instead, they submit their ad to a network, an exchange, or other ad delivery service, along with selected demographic profiles of individuals to target; e.g., Women age 26 to 39 years old, college educated, household income of $55,000 or higher, sports enthusiast, etc. Whenever an individual matching the target criteria visits a web page that participates in the services network, then the marketer's ad will be delivered, in near real-time, to that site and displayed.

Operators of DED's, particularly outdoor DED's, offer targeting capabilities similar to traditional media in that marketers choose which ads to display on which DED's based upon the average demographic profile of the DED's viewing audience, and sometimes the time of day or day of week. As the vast majority of DED viewers are transient, the average demographic viewer profiles are determined over extended periods of time, such as weekly, monthly or yearly. However, most DED's frequently change messages, sometimes as rapidly as every 8 to 10 seconds. Consequently, the demographic profiles of a viewing audience at any specific time can vary significantly during such short message display time periods. This, in effect, renders the ability of marketers to reach their target audience with DED's to essentially random chance and therefore, dramatically lowers the effectiveness of their advertising.

To compensate, DED operators and marketers increase the frequency of times their ads are displayed on DED's to improve the probability they reach their targeted audience. This results in inefficiencies for marketers as an appreciable number of their advertisements are delivered to non-targeted viewers. DED operators also suffer from such poor targeting capabilities because they must reserve more display time for each advertiser, thereby limiting the number of customers per DED. And lastly, the viewing audience experience is diminished as they are presented with advertisements unrelated to their interests.

### SUMMARY

Accordingly, it is an object of the present invention to overcome the foregoing challenges and shortcoming in existing systems and sign display methods. A method, system, device and computer program is provided for creating, storing, collecting data, analytically processing, and delivering data displaying content via digital electronic signs, digital message boards and other designated display devices based upon variable sets of display criteria and display parameters, thus combining input from both parties that wish to display content on a DED and the party that manages what and when content is displayed on the DED.

In one example, a method of dynamically delivering visual content on a digital electronic display comprises the steps of providing a digital electronic display that is positioned to display visual content to a viewing audience, wherein the digital electronic display is operatively controlled by a digital electronic display server, and the digital electronic display server contains a plurality of different content files. Each content file comprises display criteria. Next, the method includes defining a display viewing area that is a geographic boundary within which the viewing audience has a line of sight of the digital electronic display. The method provides a location identifier for identifying one or more individuals of the viewing audience that is in or approaching the display viewing area and collects location data from the location identifier and comparing that location data to the display criteria. Based on the comparison of the location data and the display criteria, the method selects and displays a specific content file on the digital electronic display. The method may include collecting demographic information about the one or more individuals of the viewing audience and incorporating the demographic information into the comparison of the location data and the display criteria to select and display a specific content file on the digital electronic display. The location identifier may detect a signal from a GPS-enabled device proximate one or more individuals of the viewing audience, and the location identifier may detect the direction of travel and speed of travel of the one or more of the individuals in the viewing audience. The viewing audience may comprise a plurality of individuals, and the location identifier creates an aggregate demographic information that is incorporated into the comparison of the location data and the display criteria to select and display a specific content file on the digital electronic display. The display criteria of each content file may include preferences with respect to the collected demographic information, and those preferences are included in the selection step for displaying a specific content file on the digital electronic display.

In another example, a method of dynamically delivering visual content on a digital electronic display comprises providing a digital electronic display that is positioned to display content to a viewing audience, wherein the digital electronic display is operatively controlled by a digital electronic display server, and further wherein the digital electronic display server is controlled by a digital electronic display owner. The method includes providing, by the digital electronic display owner, a user with access to the digital electronic display server; inputting, by the digital display owner and/or the user, content files into the digital electronic display server wherein the digital electronic display server contains a plurality of different content files, and wherein each content file comprises display criteria; inputting, by the digital electronic display owner, a set of display parameters, wherein the digital electronic display server determines a specific content file to display on the digital electronic display according to the display criteria associated with each content file and also according to the owner display parameters; and displaying the specific content on the digital electronic display consistent with the display criteria and the display parameters. The digital electronic display may comprise a display surface, and the display surface is adapted to be split into a plurality of subsections that enable a plurality of content files to be displayed simultaneously. The digital display owner may have approval rights over all content that is input into the digital electronic display server by a user before that content is displayed on the digital electronic display, and the digital electronic display owner may be the owner of the property where the digital electronic display is located, and the user is a tenant on that property owned by the digital electronic display owner. The method may further comprise the step of providing, by the digital electronic display owner, a plurality of users with access to the digital electronic display server to enable the plurality of users to input content files into the digital electronic display server. Each content file may comprise display criteria selected from the group consisting of time of day of the display of the content file, length of time of display of the content file, size of the display of the content file, creator of the content file, and user display fee paid for the content file display. The owner display parameters may comprise parameters selected from the group consisting of an amount of fees paid by a user, user demand for a display time, user demand for a display space, and contractual obligations with a user. The owner display parameters may comprise allocations of total content display time for each of the plurality of users.

### BRIEF DESCRIPTION OF THE DRAWINGS

FIG. 1 is a schematic flowchart that demonstrates the various components and functionality of a system and method described herein.

FIG. 2 is a pie chart illustrating an example of a user allocation of display of visual content files.

FIG. 3 is a comparative graph that shows the dynamic variability of demographics of a viewer of a digital electronic display over time.

FIG. 4 is another comparative graph that shows the dynamic variability of demographics of a viewer of a digital electronic display over time.

FIG. 5 is a schematic drawing of the various zones described in a method and system herein.

FIG. 6 is a functional chart showing the operation of the various zones described in a method and system herein.

FIG. 7 is a schematic flowchart that demonstrates the various components and functionality of an alternative system and method described herein.

### DETAILED DESCRIPTION

The methods and systems described herein present a significant advantage for sign owners and marketers to better realize the benefits and value of DED's with an integrated set of solutions; distributed functional access; global controls; expanded reporting and scheduling; and means for monetization. The integrated solutions aspect includes system functions available to create, store, import and edit content, and then deliver the content to the DED. Distributed access means that the system and method may assign functional abilities to one or more end-users, including non-affiliated users. Global controls centrally set and control selected conditions, performance parameters, and other restrictions that apply globally to all users and a designated DED. Reporting and scheduling functionality designate conditions for presentation display, including date, day of week, time of day, and other criteria. Additionally, it may include functions to generate performance-based reports for validation or other commercial uses. And with respect to monetization, the system and method for sign owners and end-users is able to promote, assign, allocate, prioritize, schedule, measure and report presentations for commercial gains.

### Explanation of Key System and Method Terms

Owner: Person acting as global administrator for entire DED System with highest level of controls; typically the sign owner, property owner, property manager, marketing manager or their assigned.
Affiliated-User: An entity that is both an Owner and one that directly benefits from DED messages promoting their own or an affiliated business (i.e. not an unrelated business).
Users: Individuals, including advertisers, assigned access to the system for creating and displaying messages (Content) on a designated DED; typically property tenants, local or regional site manager, marketing manager, or their assigned.
Sub-Users: Individuals assigned limited access or controls under a User.
Advertiser: An entity that promotes one or more brands, products or services.
Third-Party Advertisement: A promotion for a product or service which is not affiliated with an Owner, User or Sub-User.
Content: A digital file including text, graphics, images, or video for display on a DED and associated audio files.
Playlist: A group of Content files designated to be displayed as a set in accordance with assigned Display Criteria and Display Parameters.
Tag: One or more unique alphanumeric (names, letters, numbers or combination thereof) attributes assigned to individual Content files or Playlists.
Allocation: Amount of daily display time or other partition of DED output assigned to each User
Actual Display Time: Amount of aggregate time or other partitioned DED output after adjusting for display variances.
Display Criteria and Display Parameters: Display Criteria and Display Parameters represent data sets and other information comprised of inputs and other variables that are used to characterize the Content and help determine what Content to display, when and for what duration. Display Criteria are typically input with the Content by a User or Owner into the display server. The Display Parameters are a set of rules or priorities, typically set by an Owner, that process the various Display Criteria and then determine the resulting Playlist. Such Display Criteria and/or Display Parameters may include the following:
Display Criteria are User conditions assigned to specific Content files to determine what Content to display and when. These criteria include the following:
   Playlist assignment that determines which Content files are included within what playlists.
   Day of week, time of day requested for display, commonly referred to as dayparting, is an assignment to Content files or Playlists that designate when the Content files are to be displayed.
   Date (day of week, year, season, etc.)—Users may designate certain dates or date ranges, including start and ending dates, for selected Content files or Playlists to be displayed. These specified dates may be related to User-specific promotions and ad campaigns, to holiday greetings or other seasonal messages, or to special events.
   Dynamic or variable inputs where Users may designate certain values or value ranges of dynamic inputs for selected Content files or Playlists to be displayed including, for instance, weather such as temperature, pollen count, humidity, precipitation values; tide or moon phase; traffic status; transportation status (flight, rail, bus schedules, etc.); or news, sports, and other current events.
   Display sequence where a User may set sequential order, randomness and repeatability of Content files.
   Sub-User set up where assignment of credentials, allocation and other functional controls to one or more Users subordinate to a single User.
   Advertiser set up where assignment of allocation, priorities and other Display Criteria is made for select brands, products or entities associated with Third-Party Advertisements.
The Display Parameters are a set of rules or priorities, typically set by an Owner, that provide for global display conditions applied to the digital electronic display device and each and all Users. Such Display Parameters may include the following:
   Digital Electronic Display Settings, which are device settings related to display output conditions such as hours of operation, brightness levels, special effects, motion, and video.
   Local Code Inputs provide for ordnances governing content, display settings (e.g., brightness), permitted rendering effects (motion, transitions, etc.), frequency or display duration, and time of day restrictions.
   User Allocation include a setting by Owner for each User represented as a percentage or number of available display time per selected time period (e.g, per day); total number of Content displays; or total number of impressions (views by public).
   Owner requirements or preferences include global settings such as pricing, display content preference commitments, or community needs (PSA's, etc.).
   Content Data Sets: Content data sets include digital Content files, advertisements and other digital messages. Each data set includes a unique digital display (Content file), User information and Display Criteria.

The system and method described herein are facilitated by a software application having a user interface (UI) for initialization and set up and that controls and functions for creating, managing and delivering Content for display to a DED and for monetizing system investment, use and operation. The software application communicates with the DED server. The application UI may set up and designate one or more DED units as an on-premise sign. The location of the DED relates to the owner or location of DED. The setup may include such information as the DED unit (make, model, display dimensions, display resolution, etc.), the operation of the DED (hours of operation, display transitions or other effects, brightness, etc.), and the location-specific values and characteristics (property address, local codes and governing restrictions, traffic volume, population or other demographic data, local advertising rates, etc.) of a DED. This information may be manually input into designated entry fields of the application UI, or some or all such information may be auto-populated with associated values (make/model of DED, geographic coordinates, etc.) via selectable variables within the UI.

A DED Owner or User may set up accounts and access for one or more Users (or Sub-Users) in the application. Such set up information may include User name, contact information and specified system functions. Such Users may, or may not, be affiliated with the DED Owner (Affiliated Users). The Users may represent multiple entities; individually or collectively. The access to the DED server may be limited with regards to functional or control capabilities, and they may be revoked, temporarily or permanently.

A User or Sub-User may permit and set up one or more Advertisers in the application. The set up information may include the Advertiser name, affiliated entities, associated Display Criteria and reporting outputs, or other attributes. The Advertisers may, or may not, be affiliated with User. The Advertisers may represent one or more entities.

The application UI may be used to allocate usage or display limits of selected DED(s) for each assigned User or other defined Display Parameters. The allocation may be defined by a percentage or other partition of usage or DED output (within a defined period; e.g., day). The Display Parameters may include available Content display time (associated with selected DED), available quantity of total files to be displayed, available quantity of total impressions (viewers), available advertising value (associated with selected DED), and total available or allowable Content file space.

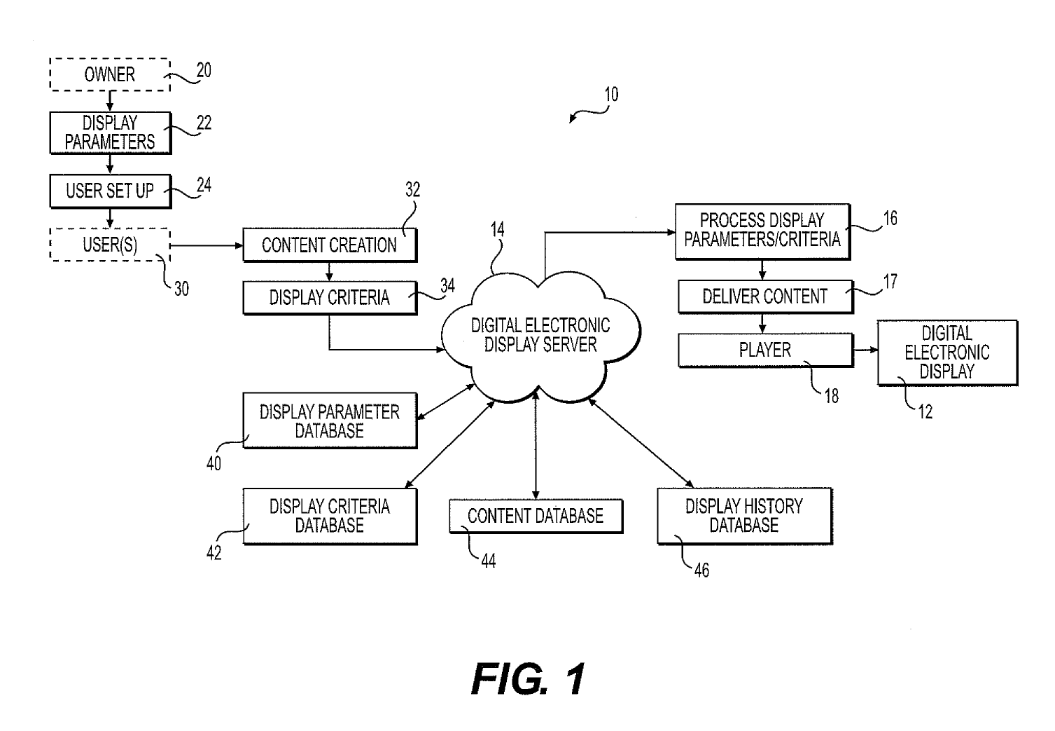

FIG. 1 illustrates the many optional features of the methods and system described herein. The system 10 for dynamically delivering content to and displaying it on a digital electronic display 12 is shown under the control of a digital electronic display server 14. The DED server 14 processes display parameters and display criteria in step 16 in order to decide on and send content in step 17 to a player 18 that manages the video and/or audio content to be shown on the DED 12. The process starts with an Owner 20 who or that sets out the display parameters 22 as described herein. A User set up is then presented to a User in order to input their desired content. One or more Users then create content in step 32 and assign Display Criteria 34 to each piece of Content. This information is then sent to the DED server 14. The DED server 14 includes several databases to store and manage its work. There is a display parameter database 40, a display criteria database 42, a content database 44, and a display history database 46. Each of these databases 40, 42, 44, and 46 holds information that is taken to and from the DED server 14 that is continuously processing the information in order to provide content for display on the DED 12 based on the dynamic input from one or more owners and users of the DED system 10. This process is discussed in more detail in the following.

When a DED is used to display Content from multiple Users, then Owner Display Parameters can be used to control relative allocation of the display time, size duration and time of day that must be allocated between those Users. For instance, in one of the most simple examples of a Display Parameter, the DED may display Content from each of multiple Users in an equally-timed, serially-presented fashion. The present system and method, however, allows for greater variability in the allocation of display when multiple Users are involved. The allocations may be defined by partitioning the total display area (similar to full page, ½ page, ¼ page, etc. for print media) of a DED. The area partitions may be of equal proportions for displayed User messages (total area is divided equally, e.g. 4 Users' messages displayed within ¼ of total area), or alternatively, the area partitions may be disproportional (allowing one or more Users' messages to be displayed in unequal partitioned areas, e.g., 1 User message displayed within ½ of area, two Users' messages displayed in ¼ area each). Two or more means of allocations may be combined for each assigned User to determine a total allocation for that User (e.g., area partition allocation may be combined with display time allocation so that User messages displayed in ¼ of total display area for 10% of total display time equates to ¼×10%, yielding 2.5% time allocation). These allocation may be assigned to Users by Owner. The allocations may be assigned to Sub-Users or Advertisers (including Third-Party Advertisers) by Users. The allocations may be assigned to Advertisers (including Third-Party Advertisers) by Owners, Users or Sub-Users. The allocations may be uniformly distributed among all Users or may be different for different Users.

Display Parameters controlling allocations may be different for different User designations, categories or other classifications as determined by Owner. These Display Parameters include allocations based upon economical or other values set by Owner (lease amounts, leased square footage, advertising budgets, advertising commitments, etc.), allocations based upon tenant category or space classification, such as anchor, sub-anchor, pad site, base unit, large, medium, small kiosk, and the like. Alternatively, the allocations may be based upon Sub-User or Advertiser classification, such as prime customer or key vendor. These allocations may be automatically assigned based upon Owner defined Display Parameters, including, but not limited to, the number of total possible (current and future) entities assigned to a selected DED, the square footage or property space classification associated with each entity, and the display time ratios between two or more User designations. Variables in the allocation process include an increase on a per User basis in accordance with parameters including, but not limited to, Users with system access on an amenity, complementary, free, or inclusive basis, Users with system access on a paid or premium basis, or Users with system access on a temporary basis. The allocations can be automatically and dynamically adjusted by the system to maintain 100% usage of available display time in the event not all users are assigned or are active within the System. In this event, time can be increased uniformly for all active Users, time can be proportionally increased in accordance to assigned allocations, time can be first distributed, uniformly or otherwise, to selected User categories (such as premium, amenity, etc.). Finally, the allocations may take into account future or anticipated Users, such as vacant spaces, planned buildings, or spaces otherwise not yet occupied.

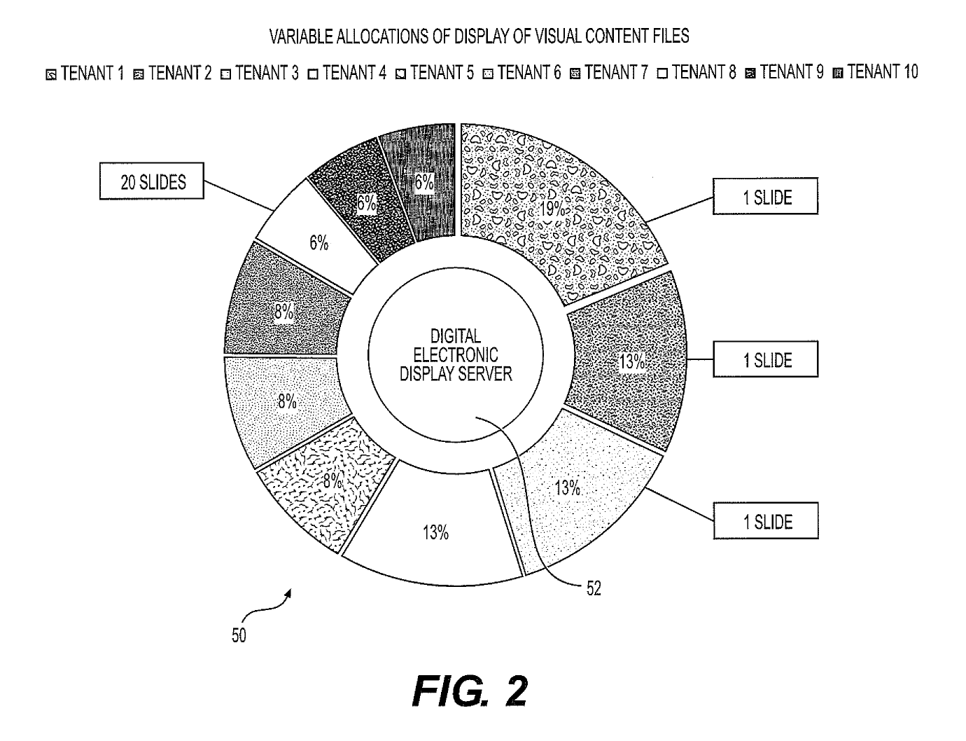

Referring to FIG. 2, there is shown a sample pie chart 50 which shows a division of display time on a DED that is controlled by the digital electronic display server 52. In this example, the digital electronic display server 52 is used by ten tenants, Tenant 1 to Tenant 10, at a hypothetical property where a DED is located. As demonstrated on the figure, the ten Tenants have unequal shares of display time as measured by the percentages in each slice of the chart 50. Further variability is demonstrated by the fact that the Tenants may have a different number of Content files (slides) for display on the DED. Tenant X has input 20 slides (Content files) to be displayed at whatever times it is allocated by Display Parameters for display on the DED sign which amount to 6% of the total display time. Meanwhile, another Tenant Y has input only one slide (Content file) to be displayed over its allocated 19% of the display time pursuant to Display Parameters.

The actual methodology of input of the Content into the digital electronic display server can be facilitated by an application user interface (UI) that may create, import, view, edit, copy, paste or save digital elements or files to produce Content for display on designated DED(s). Digital elements and files may include text, graphics, videos, or images that may originate within the application or that may originate from third-party sources. The Content may be inherently or automatically formatted for display on designated DED(s), or it may be modified to meet formatting or other requirements. Other features of the application may include graphics templates, background, thematic borders or other graphical enhancements to facilitate Content creation, modification and variability that can be premade and/or created, imported and stored by Users or Sub-Users.

One type of Display Parameter includes an Owner review, control and approval of User Content files before they are allowed to be displayed on the DED. The Content files may be automatically compiled for review by Owner or the Owner may be notified via email, mobile text or other electronic means of pending Content file reviews. The Owner may approve or reject a Content file via checkbox or other selection mode. The Owner may provide written comments to Content User/creator relating to rejection or approval conditions. The Users or Sub-Users may be automatically notified of such approval, rejection or comment actions via application UI, email, mobile text or other electronic means.

The actual creation of a Playlist may include input from both an Owner and Users. In a simple example, the Playlist is determined solely by an Owner using specific Display Parameters. Alternatively, there can be more active and dynamic User participation by a User to select and modify a Playlist, typically using some Display Criteria associated with a Content file. For instance, a User may request, and perhaps pay a premium, for a specific Content file to be played more often and for longer and at a specific time of day. The Display Parameters can process these Display Criteria requests when developing the final Playlist.

An application UI may create Playlists or otherwise group individual Content files to facilitate organization and display processing. A Playlist may be manually constructed via drag and drop UI feature, via checkbox or other selectable means, and via tag or other attribute selection. Alternatively, a Playlist may be automatically constructed in accordance to selected Display Parameters.

An application UI may establish named dates or date ranges for display of a particular Content file. Those dates or date ranges can be established within a rolling 12-month calendar. They may be associated with holidays, promotions, ad campaigns, events or other important retailing interests. The dates or date ranges may be named, saved, modified or stored.

An application UI can establish Display Parameters for each unique Content file including User, Sub-User or Advertiser allocation, Playlist assignment, allocated time of day or day of week (Dayparting) for display, a date or date range, other predefined or definable attributes related to User, Sub-User or Advertiser, display history, sequence setting or other selected preferences, prioritization, pricing or other user-defined settings, and other defined or definable values or value ranges (temperature or other environmental variables, traffic conditions, product stock levels, etc.).

An application UI can assign “tags” or attributes for selected Content files or playlists to facilitate searching, creating playlists, reporting, allocation or establishing Display Parameters. These tags may be manually or automatically assigned, may represent qualitative values or descriptions, and/or may include quantitative or other defined values.

The systems and methods described herein may utilize a single DED server database or sets of databases. A database may contain information pertaining to Users, Sub-Users, Advertisers, and associated relationships, assigned functional control capabilities, assigned DED and other related account information. A database may contain information relating to local codes and governing restrictions, traffic density, population or other demographic data, local advertising rates, etc. A database may contain Advertiser pricing or other value-based information pertaining to co-op advertising, manufacturer development funds or other payments related to individual Content files or playlists, a database may contain files representing unique Content and associated Display Criteria, and a database may contain information relating to Content display history and other performance related records.

A combination of Display Parameters can include a set of algorithms in a display server to process Display Criteria to initiate Content delivery for display. The display server can transmit Content for display on a DED. Display Parameters may be communicated through the display server by an application UI of inputting or otherwise assigning pricing or other value-related information for individual Content files, Advertisers, property locations, DED's, Users or Sub-Users. The application UI can generate reports of Content display history (proof of play) and other performance-related data, such reports may be by defined date range, such reports may be defined by User, Sub-User or Advertiser, reports may be defined by owner, property location or DED, such reports may be defined by other selected attributes or parameters, such reports may include monetary or other values associated with Content display history, such reports may be used by Users or Sub-Users to substantiate claims to third-party Advertisers for co-op advertising, MDF or other reimbursements associated with Content display history, such reports may be exported to PDF, MS Excel, CSV or common output formats, and such reports may be automatically generated and electronically distributed to assigned Users, Sub-Users or Advertisers.

The system, means and method of interacting with and integrating third-party applications or data sources may facilitate Content creation, Content display, reporting, and monetization with application.

The system and method described herein provides a new means and method of marketing DED use, Content, exposures, views, impressions or associated value propositions to Users, Sub-Users and Advertisers and monetizing same. The benefits that may be marketed include documented values related to local, regional or national advertising rates, the rates may be in the form of cost per impressions (CPM), may include estimated or documented values relating to traffic volume or viewer estimates (specific to location of DED), documented values may combine local advertising rates and location-specific viewer estimates to determine advertising value of selected DED, information related to initial and operating costs, projected value monetization and associated ROI. The new marketing may include information to facilitate monetization of DED Content with specific examples of value chain and proposed relationship for Owner, User, Sub-user and Advertisers, and may include estimated values of Third-Party Advertisements based upon local and other applicable rates for Co-Op advertising, MDF, or other reimbursements from vendors and other Third-Party Advertisers.

The system and method described herein enable a method of accessing controls and functions via application UI for creating, managing and delivering Content for display on DED and monetizing System operation. The access may be distributed to one or more Users or Sub-Users including Users or Sub-Users are not otherwise affiliated with a DED Owner. This access allows Users or Sub-Users to perform routine or necessary System operations without involvement of DED Owner. It further allows non-Affiliated Users to access controls and functions via an application UI for creating, managing and delivering Content for display on DED and monetizing System operation where total display time (per selected periods, e.g., day) may be allocated by Owner on a per User or per User category basis, the allocations may be the same for each User, the allocations may be different for each User or User category as determined by Owner, and the allocations may be sub-allocated by Users to Sub-Users.

Furthermore, in an alternative example, a system and method may dynamically deliver digital content for transient viewing audiences as outlined herein. The system and method works as an ad server for digital signs and electronic message boards (DED's). The system determines what Content to display for select DED's and for how long, in real-time, based upon the aggregate demographic profile of the real-time, transient viewing audience, viewers' direction of travel and the average viewer speed of travel within the viewing range of the DED.

The alternative method and system presents a significant advantage for marketers to improve the effectiveness of their advertisements to transient viewers by allowing (near) real-time targeting and Content delivery to DED's for select consumer segments and adjusting the display period to maximize viewing exposure to such segments. The system tracks individuals via assigned mobile, GPS enabled devices, or other location-based identifiers, and available associated demographic data, in real-time, identifying the number, speed and direction of those viewers moving relative to a predetermined viewing range of a DED. These variables are used to determine an aggregate demographic profile of the viewing audience for the selected viewing period (i.e., 10 seconds of message display) and an average time in the viewing area. These set of inputs, along with other available data sets, are processed to determine what Content to deliver to DED and for how long (Display Criteria).

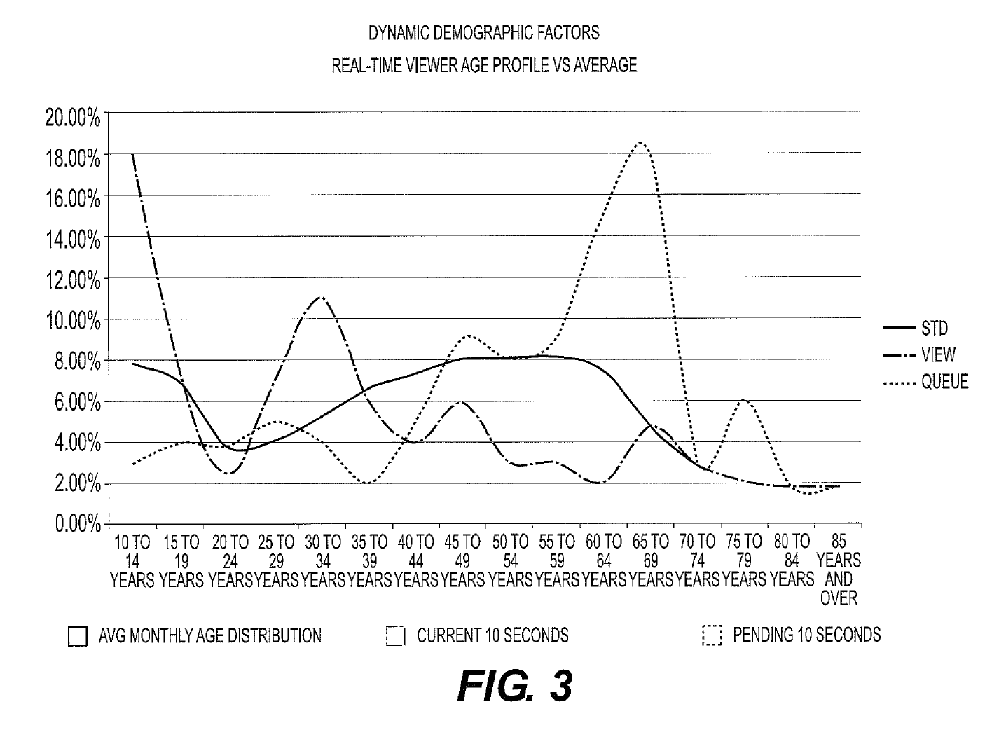

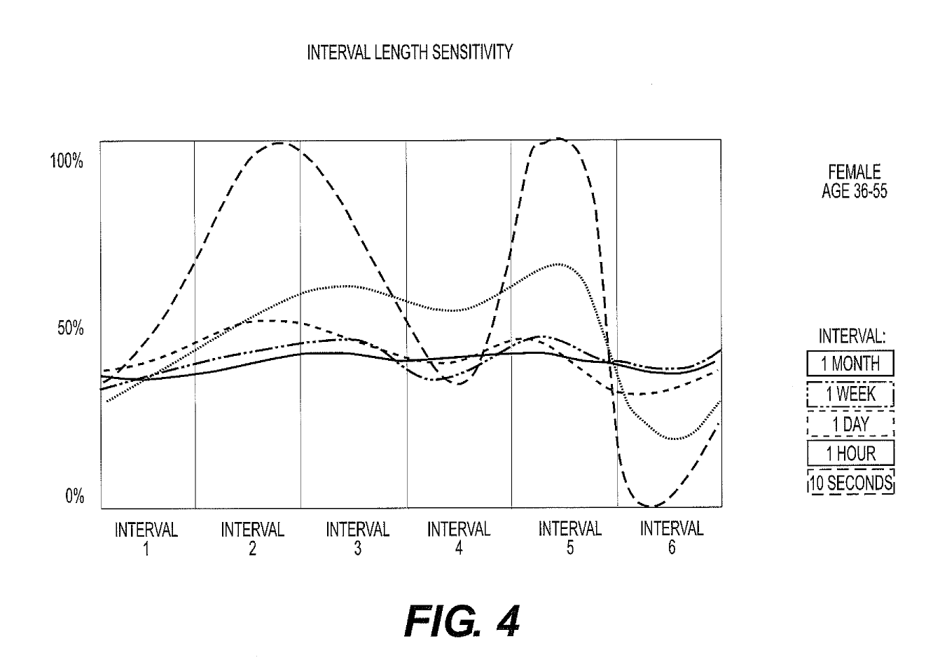

FIGS. 3 and 4 are graphs that illustrate hypothetical, representative demographic variability with respect to a viewing audience of a specific DED. In FIG. 3, the graph shows the real-time (current ten seconds and next ten seconds) viewer age for a viewing audience versus a longer average of that viewing audience (monthly average age distribution). In FIG. 4, the variability of the average population of a specific age group is shown by short-term averages (ten seconds) up to a longer sample of one month. The present system and method can capture accurate demographics in near real-time and therefore deliver the most effective content for that viewing audience.

The system and method comprises a defined geographic or virtual boundary, such as a geo fence, representing the viewing area for an electronic display; a location identifier to identify and track the location, velocity and direction of individuals via associated mobile phone, other GPS enabled devices, or other location-based methods, to generate locating data, or telematics data, relating to such individuals; a database of digital files representing advertisements and associated presentation criteria, including target demographic profiles; a database of individual consumers and associated demographic information; a set of algorithms and programs to process telematic data and presentation criteria to control file transmission; and a means of transmitting digital file data to electronic receiving and display systems.

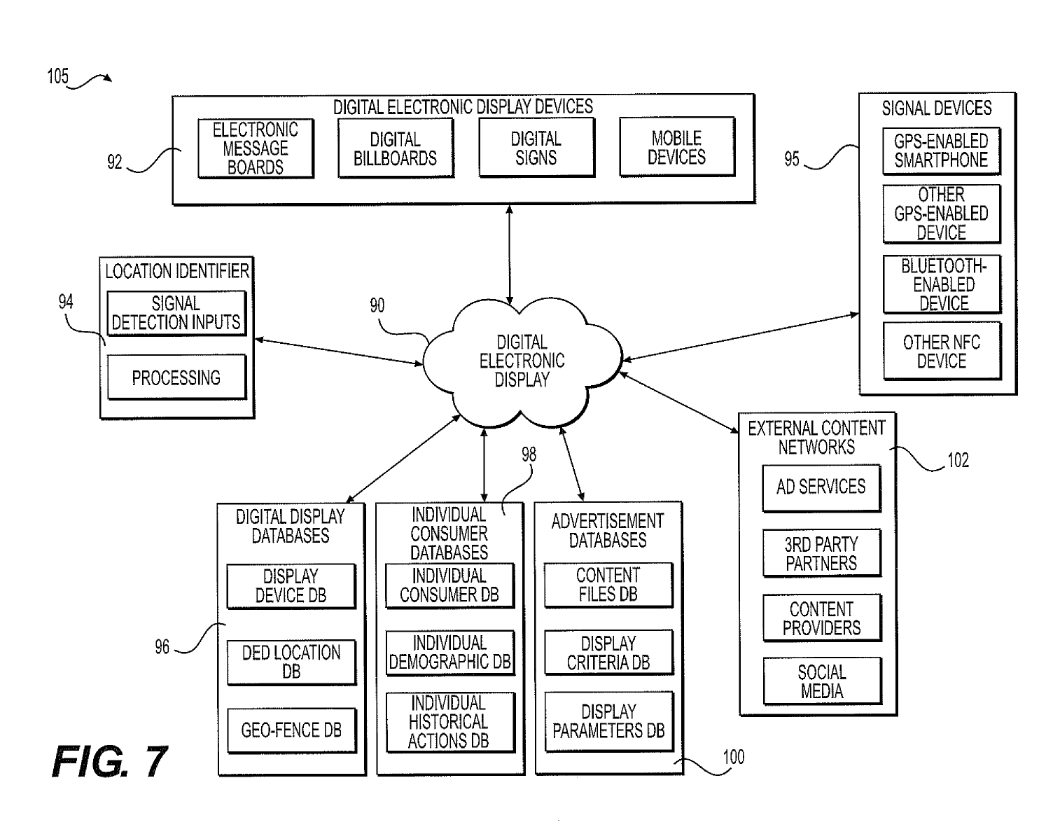

FIG. 7 is an overview schematic that demonstrates the interactivity of the dynamic system and method in this example. At the heart of the system 105 is the digital electronic display server 90. The DED server 90 interacts continuously with multiple outside databases and with outside hardware. The DED server 90 is operatively connected to a digital electronic display device 92 that may be in one of the several forms listed. The interactivity between the DED server 90 and one or more of the digital electronic display devices 92 can be similar or different to the functionality described earlier herein, for instance in connection with FIG. 1. In operation, a location identifier 94 is used to detect a signaling device 95 that is coming into a zone of interest to the system. The DED server 90 then interacts with one or more additional databases such as a digital display database 96, an individual consumer database 98, an advertisement database 100, and/or an external content network 102 in order to deliver the best match of content on a digital electronic display device 92.

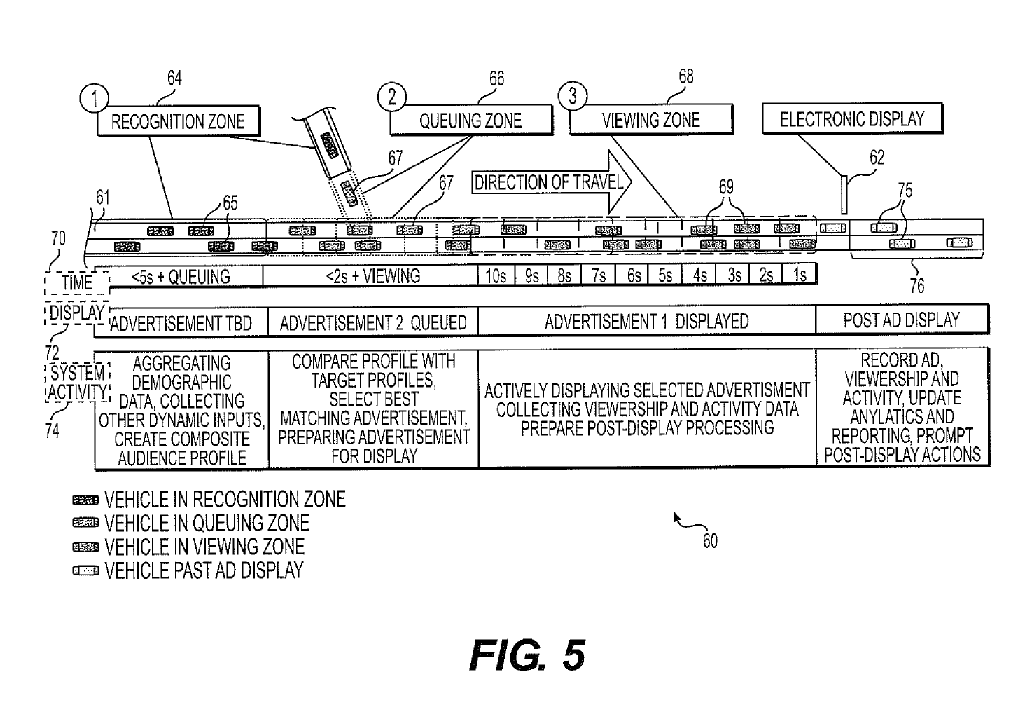

FIG. 5 illustrates one example of the system and method described herein. This is a single example of vehicles traveling on a road next to a DED. This is an inherently transient setting where the viewing audience will have only a relatively limited amount of time to view the DED. As shown, the schematic map 60 of a Digital Viewing Area that includes a road 61 and a DED 62. This example of a road and vehicles is one sort of a transient setting. Other examples include malls, walking shopping districts, and public transportation settings such as airports, train stations and subway stations. Other alternative settings for the system and method described herein include sporting events and other public gatherings and festivals. The audience is still transient, but some of the viewing audience may be relatively stationary as compared with a drive-by sign setting.

The following includes key system terms and descriptions, also referring to FIG. 5.

The Display Viewing Area (DVA) 60 is a defined or dynamic boundary or set of boundaries, i.e., a geo-fence, unique to each electronic display in the system as determined by both fixed and dynamic parameters. It may be of any area, but the preferred embodiment encompasses the entire area with practical line of sight, or readability, to the designated DED 62 and a defined vicinity beyond such area. Such boundaries may be of varied geometric shapes, including but not limited to a) triangular, expanding out away from the display; b) rectangular, from the DED, stretching away and conforming to roads or other travel corridors; or c) irregular shaped or non-contiguous areas as influenced by physical structures or other obstructions of view. Each DVA is segmented into at least two areas that segment the active and pending viewing zones. The preferred embodiment comprises three primary zones, ascending in the direction of travel towards the DED:
1. The Recognition Zone 64 represents the outer vicinity beyond the viewing area where the system recognizes a unique device of which position, speed and direction indicates it will enter Zone 2, the Queuing Zone 66, within a defined time interval. Additionally, the system will collect and compile available demographic and individual data associated with the recognized, unique devices. In FIG. 5, the individual devices are shown as vehicles 65 (Recognition Zone 64), vehicles 67 (Queuing Zone 66), and vehicles 69 (Viewing Zone 68).
2. The Queuing Zone 66 represents the inner vicinity between Recognition Zone 64 and the viewing area where the system identifies those unique devices exiting the Recognition Zone 64 and whose position, speed and direction indicates it will enter the Viewing Zone 68, and processes the aggregated demographic data collected and the presentation criteria to determine which digital content file to deliver for display on the DED.
3. The Viewing Zone 68 represents the practical and optimal range for viewing the electronic display 62 where the system delivers a digital message (i.e., advertisement) for display in accordance with the presentation criteria.

An additional zone 76 may be considered that represents the vicinity immediately following the Viewing Zone 68 for certain post-display actions and system processing after the viewer has had the opportunity to view the DED. These post-display actions may include, but are not limited to, the number of times and duration of each unique ad displayed within selected time periods, the aggregate duration of each unique ad displayed, the number of unique viewers, along with demographic profiles, for each unique ad displayed, and the value of each unique ad displayed. A viewer activity (response) for each unique ad displayed can include an ad acknowledgement, an offer-related activity (i.e., coupon acceptance, coupon redemption, etc.), and social media activity (i.e., Like, tweet, etc.). Campaign updates or other marketer-defined actions can likewise be taken or planned.

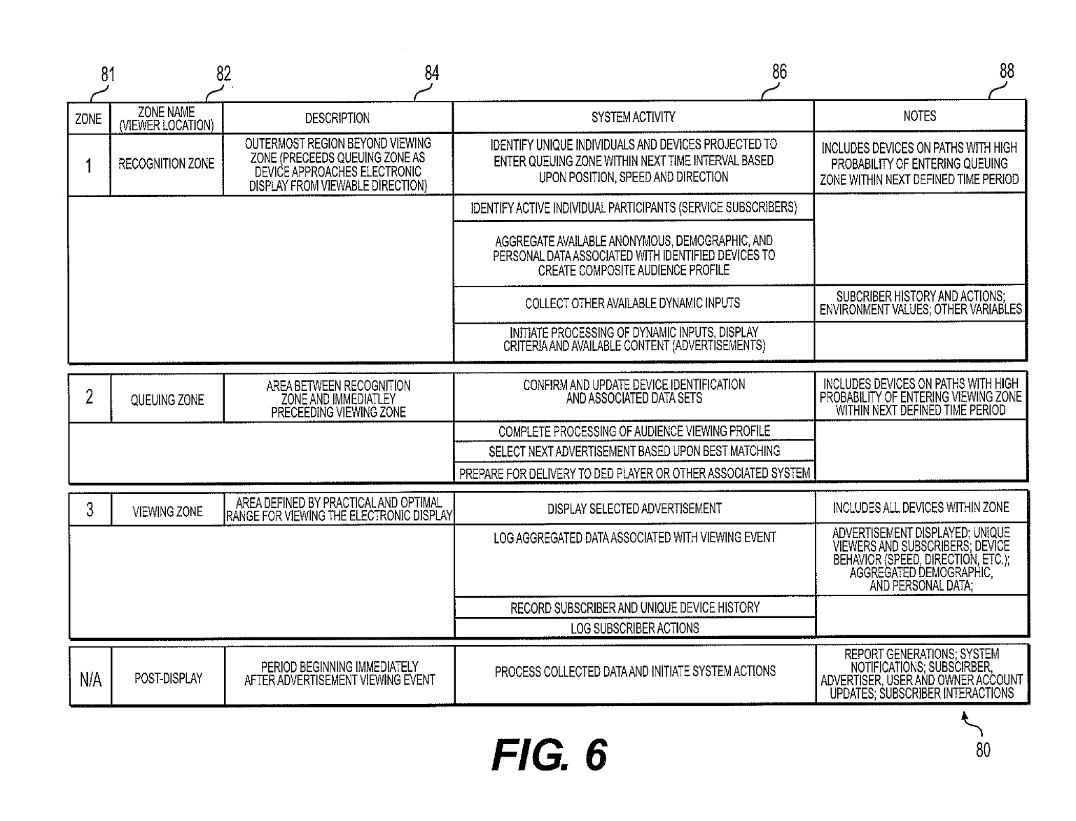

FIG. 6 is a chart sets forth the Zone 81, the Zone Name 82, the Description 84 of the location of the particular Zone, the System Activity 86, and then Notes 88 about the examples of the purpose and actions of the system and methods described herein.

Each of the foregoing zones may vary in size, dynamically expanding or contracting, depending on average speed and direction of individual devices detected within or other factors. Specific device and user information may be detected by location-based technologies including GPS-enabled devices, Bluetooth, Wi-Fi and similar technologies. Other location-based sensing methods include visual image recognition, radar, sonar, other signal feedback methods, and cellular or other triangulation methods.

Individual Data may be retrieved from a database or sets of data containing information relating to individuals and/or their trackable devices that are tracked within designated DVA's or otherwise contained within a system or accessed from third-parties. Two primary types of data may be of use to track individuals within a DVA; anonymous and demographic. Anonymous data may be acquired via mobile phone carriers or other third-party sources with access to large sets of GPS enabled device identifiers or other location-based sensing methods. The system does not require personal data, only the ability to detect the presence and associated Location Data of a unique device within the DVA. Demographic data would include personal information associated with a unique device provided by individuals or other sources with rights to provide such data. Demographic data may include, but is not limited to, basic information about individuals' age, sex, race, household income, education level, number of children and ages, etc. to more detailed information relating to consumer behavior, travel patterns, individual preferences, etc.

The system and method herein may save and make available system-generated data (for each unique individual detected), unique ads viewed including a passive and active viewing history, active viewing responses, and post-ad actions. Aggregate viewing information can be saved as well as other individual-supplied data (name, email address, social links, etc.).

Display Criteria includes data that describe conditions associated with a selected DED and each Content file (along with audience viewing profile and other inputs) to determine what Content to display, when and for how long. These criteria may include marketer determined preferences, target demographic priorities, programmed conditions such as time, day, date, DED geographic location, number of total displays, and sequence of display. Other dynamic conditions may also be considered including weather, environmental, traffic, user actions or interactions, and sports scores, or other dynamic inputs. Other factors for determining the Playlist include Owner Display Parameters such as pricing or other economic factors, advertiser priority, content priority (PSA's, other urgent community needs), and local ordinances governing content, display settings (e.g., brightness) frequency or display duration.

A Viewing Audience Profile is a composite representation of the aggregate values for select demographic and other factors for a transient viewing audience (i.e., viewing audience in or predicted to enter DVA or DVA zone). Values are based upon system-collected and other available data processed via system algorithms and programs. Sample graphs with respect to age-related demographics are shown in FIGS. 3 and 4. Such data may also include number of unique individuals or devices within selected DVA zone, average speed and direction of viewing audience, values for discrete demographic factors (e.g., age, sex, etc.), data strength (percent available factors vs non-available), data confidence, etc., and a composite score for entire audience or select factors (based upon pre-established weighting or other scoring method).

A Playlist represents the output of the display server processing of Audience Viewing Profile, Display Criteria, and other factors together with Display Parameters to determine the following for a designated DED—what Content is to be delivered for display, when to display that Content, and how long each Content is to be displayed.

Content Delivery is the transmission by the DED server to a designated DED, audio receiver, and associated systems and devices (such as a “player”) of selected Content files, or a signal to such systems which in turn causes the selected Content to be displayed, broadcast or otherwise played.

A Display Network is one or more DED, audio or other systems and devices can be linked to form a network for simultaneous or coordinated Content Delivery. These Display Networks can be used to simultaneously deliver content files to one or more DEDs or the Display Networks can allow for coordinated delivery of related content files to multiple DED's in sequential fashion, relative to viewers traveling from one DVA to another.

Additionally, the system and method may be augmented with a number of other features and capabilities to maximize individual engagement, use, and satisfaction for the transient viewing audience; and also enhance the effectiveness for marketers and DED operators. In one example, smart phone or other mobile applications for individual use may incorporate gaming elements, or gamification, to promote interaction and satisfaction for individual users. Such gaming elements are well-known in other applications and may include, but not limited to, points, badges, levels, status indicators, social interaction, and rewards. Below describes User activities to be promoted within such an application. Each of the following represents possible actions for a User to collect points (or otherwise gain credit for system participation) include passive participation—collect points for passing displayed ads while the app is enabled, and active participation during both the ad display period (interactive options such as tap the app or otherwise acknowledge when requested by DED, receive an offer from DED (opt in), text message, app notify, a phone call, text picture of DED to advertiser, social media, etc., and capture a coupon code (manually or via photo); and post-ad display period (review displayed ads (on app, web browser, etc.) from passed DED's, select offers or ads of interest, visit advertiser web site, or redeem offers or initiate other actions.

Additionally, the system may be integrated with mapping programs to allow Users to see approaching or past DED's to further enhance their system participation experience.

As will be appreciated by one skilled in the art, aspects of the present invention may be embodied as a System, device, method or computer program product. Accordingly, aspects of the present invention may take the form of an entirely hardware embodiment, an entirely software embodiment (including firmware, resident software, micro-code, etc.) or an embodiment combining software and hardware aspects that have been or may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. If the service is also available to applications as a REST interface, then launching applications could use a scripting language like JavaScript to access the REST interface. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (Systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based Systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed is:

1. A method of dynamically delivering content on a digital electronic display, the method comprising the steps of:
providing a digital electronic display that is positioned to display content to a viewing audience, wherein the digital electronic display is operatively controlled by a digital electronic display server, and the digital electronic display server contains a plurality of different content files;
wherein each content file comprises display criteria;
defining a display viewing area that is a geographic boundary within which the viewing audience has a line of sight of the digital electronic display;
providing a location identifier for identifying one or more individuals of the viewing audience that is in or approaching the display viewing area;
collecting location data from the location identifier and comparing that location data to the display criteria; and
based on the comparison of the location data and the display criteria, selecting and displaying a specific content file on the digital electronic display.

2. A method of dynamically delivering content on a digital electronic display as described in claim 1,
collecting demographic information about the one or more individuals of the viewing audience and incorporating the demographic information into the comparison of the location data and the display criteria to select and display a specific content file on the digital electronic display.

3. A method of dynamically delivering content on a digital electronic display as described in claim 1,
wherein the location identifier detects a signal from a GPS-enabled device proximate one or more individuals of the viewing audience.

4. A method of dynamically delivering content on a digital electronic display as described in claim 1,
wherein the location identifier detects the direction of travel and speed of travel of the one or more of the individuals in the viewing audience.

5. A method of dynamically delivering content on a digital electronic display as described in claim 2,
wherein the viewing audience comprises a plurality of individuals, and the location identifier creates an aggregate demographic information that is incorporated into the comparison of the location data and the display criteria to select and display a specific content file on the digital electronic display.

6. A method of dynamically delivering content on a digital electronic display as described in claim 2,
wherein the display criteria of each content file includes preferences with respect to the collected demographic information, and those preferences are included in the selection step for displaying a specific content file on the digital electronic display.

7. A method of dynamically delivering content on a digital electronic display, the method comprising the steps of:
providing a digital electronic display that is positioned to display content to a viewing audience, wherein the digital electronic display is operatively controlled by a digital electronic display server, and further wherein the digital electronic display server is controlled by a digital electronic display owner;
providing, by the digital electronic display owner, a user with access to the digital electronic display server;
inputting, by the digital display owner and/or the user, content files into the digital electronic display server wherein the digital electronic display server contains a plurality of different content files, and wherein each content file comprises display criteria;
inputting, by the digital electronic display owner, a set of display parameters, wherein the digital electronic display server determines a specific content file to display on the digital electronic display according to the display criteria associated with each content file and also according to the owner display parameters; and
displaying the specific content on the digital electronic display consistent with the display criteria and the display parameters.

8. A method of dynamically delivering content on a digital electronic display as set forth in claim 7,
wherein the digital electronic display comprises a display surface, and the display surface is adapted to be split into a plurality of subsections that enable a plurality of content files to be displayed simultaneously.

9. A method of dynamically delivering content on a digital electronic display as set forth in claim 7,
wherein the digital display owner has approval rights over all content that is input into the digital electronic display server by a user before that content is displayed on the digital electronic display.

10. A method of dynamically delivering content on a digital electronic display as set forth in claim 7,
wherein the digital electronic display owner is the owner of the property where the digital electronic display is located, and the user is a tenant on that property owned by the digital electronic display owner.

11. A method of dynamically delivering content on a digital electronic display as set forth in claim 7, further comprising
providing, by the digital electronic display owner, a plurality of users with access to the digital electronic display server to enable the plurality of users to input content files into the digital electronic display server.

12. A method of dynamically delivering content on a digital electronic display as set forth in claim 7,
wherein each content file comprises display criteria selected from the group consisting of time of day of the display of the content file, length of time of display of the content file, size of the display of the content file, creator of the content file, and user display fee paid for the content file display.

13. A method of dynamically delivering content on a digital electronic display as set forth in claim 7,
wherein the owner display parameters comprising parameters selected from the group consisting of an amount of fees paid by a user, user demand for a display time, user demand for a display space, and contractual obligations with a user.

14. A method of dynamically delivering content on a digital electronic display as set forth in claim 11,
wherein the owner display parameters comprise allocations of total content display time for each of the plurality of users.
